(19) United States
(12) Patent Application Publication
(10) Pub. No.: US 2002/0038240 A1
(43) Pub. Date: Mar. 28, 2002

(54) Advertisement display apparatus and method exploiting a vertual space

(75) Inventor: Manabu Kondo, Gunma (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD.

(21) Appl. No.: 09/823,627

(22) Filed: Mar. 30, 2001

(30) Foreign Application Priority Data
Sep. 28, 2000 (JP) 2000-296878

(51) Int. Cl. G06F 17/60

(52) U.S. Cl. 705/14

(57) ABSTRACT

An advertisement display technique that enables advertisers to advertise in a friendly and interactive manner in virtual reality is provided. A user explores a virtual space with his/her user agent. The advertisers provide their service agents having their advertisements in a virtual space. When the user agent approaches to the one of the service agents, the service agent interacts with the user and displays the advertisements. The user may earn some points when the advertisements are displayed. Some of the service agents can be set invisible, when the user agent is far away from the service agents. The user can enjoy discovering the invisible service agents, while exploring the virtual space.

### BACKGROUND OF THE INVENTION

1. Field of the Invention

The present invention relates to advertising technology, and it particularly relates to an advertisement display apparatus and method for users to be advertised in an interactive manner in a virtual space.

2. Description of the Related Art

Since the Internet access at home has been common recently, WWW (World Wide Web) users are growing rapidly. As it is convenient for the users at home to access to a huge amount of information from all over the world, the number of the users is further increasing.

As the population of the Web users grows, the WWW is also playing a role as advertising media. Many advertisers place their advertisements on their-Web sites and the other popular Web sites. If the advertisements are placed on the other's Web sites, the advertisers can provide their advertisements with links to their own Web sites so that they can redirect the users to their Web sites easily. The conventional media such as TV, radio, and newspapers do not have such a feature.

On the other hand, since the technology related to virtual reality is greatly advancing, it is realized that the users explore a virtual 3-D space and receive various services from virtual stores there. When Web-based services are associated with such virtual reality, the information services will be enhanced with a sense of reality and attract more users.

When the information services are offered in virtual reality, more attractive and effective advertising methods will be required. The conventional advertising methods such as a banner advertisement on a Web page lack interaction with users, so that it cannot expand the possibility of the information services realized in the virtual reality. An advertising method for utilizing the potential features of the virtual reality has been desired.

### SUMMARY OF THE INVENTION

It is therefore an object of the present invention to provide an effective advertising technique to present advertisements to users in a virtual space. It is also an object of the present invention to provide an advertisement display method and apparatus for users to be advertised in a friendly and interactive manner in virtual reality.

According to one aspect of the present invention, an advertisement display apparatus is provided. The apparatus includes an object storing unit, an object outputting unit, and an agent process executing unit. The object storing unit stores object data that describe a virtual 3-D space, a service agent and a user agent. The virtual space includes a plurality of virtual service mall or service store, as also simply referred to as a virtual store. The service agent personifying a service provider is located in the virtual space to be explored by a user. The service agent has advertisement data and presents the data to the user. The user agent personifying the user can move through the virtual space, converse with the service agent and receive services from the virtual store. The advertisement data are provided by an advertiser or service provider. The advertisement may be stored in the service agent in advance, or may be received from the advertiser's server on demand. The functions of the service agent and the user agent may be implemented in any combination of hardware or software components.

The object outputting unit displays the service agent and the user agent in the virtual space. The agent process executing unit enables the service agent to initiates to interact with the user when the user agent is in the neighborhood of the service agent. The object outputting unit displays said advertisement data of the service agent, when the user responds to the interaction initiated by the service agent.

The function of the apparatus may be implemented in a server-client system via the Internet. The client may act a front-end processing unit which receives the operation from the user and executes the process of the agents. The server may act a back-end processing unit which controls the agents and provides advertisement data. The back-end processing unit may include a user database, an advertisement database, and an object data providing unit that extracts necessary data from an agent database and provides the front-end processing unit with the object data including the advertisement data. The object data providing unit can be configured in various manners such that the main functions remains at the server side like CGI or Common Gateway Interface, the main functions are transferred to the client side like a Java (trademark) applet or ActiveX (trademark), and an API or Application Program Interface type, that is, the main functions are provided at both the server and the client like a Java application.

The object outputting unit may display the service agent when the user agent is in the neighborhood of the service agent, and make the service agents invisible when the user agent is not in the neighborhood of the service agent.

The agent process executing unit may move the service agent to the user agent when the user agent is within a specific region defined for each of the service agents, and the object outputting unit may display the moved service agent. For each service agent, the specific region where the service agent wishes to meet the user agent is defined. Even if the service agent is not located in the predefined region, once the user agent enters into the region, the service agent can move to the user agent and start to interact with the user. A plurality of such regions may be provided for each service agent, and when the user agent is within any of the plurality of the regions, the service agent may be moved to the user agent and displayed.

The service agent has an advertisement data provided by a virtual store in the virtual space, and said agent process executing unit moves the user agent to the virtual store when the user responds to the displayed advertisement data.

The agent process unit may award a point to the user when the user responds to the service agent and the advertisement data is displayed. The agent process unit may award a point to the user when the user agent is moved to the virtual store. The agent process unit may award a point to the user when the invisible service agent is discovered through the user's exploration and the advertisement data in the service agent is displayed.

According to another aspect of the present invention, a server is provided. The server is shared by a plurality of users exploring a virtual space. The server includes an advertisement database which stores advertisement data to be offered to a user, a user database which stores the user's personal data, a set of software components which realize a user agent that personifies the user and moves through the virtual space explored by the user, and a set of software components which realize a service agent located in the virtual space that initiates to interact with the approaching user agent. The service agent has a function for extracting the personal data of the user corresponding to the interacting user agent, a function for extracting the advertisement data matched to the personal data from the advertisement database, and a function for presenting a user with the extracted advertisement data.

According to still another aspect of the present invention, a server-client system is provided. The system has a server shared by a plurality of users exploring a virtual space, and a user terminal accessing to the server via a network. The server includes an advertisement database which stores advertisement data to be offered to a user, and an object data providing unit which provides object data that describes a user agent that personifies the user and moves the virtual space explored by the user, and a service agent located in the virtual space that presents the user with the advertisement data. The user terminal includes an object storing unit which stores object data of the service agent and the user agent provided by said server, an object outputting unit which displays the service agent and the user agent in the virtual space, and an agent process executing unit which enables the service agent to interact with the user when the user agent is in the neighborhood of the service agent, and displays the advertisement data according to the reaction of the user.

According to yet another aspect of the present invention, an advertisement display method is provided. The method includes arranging a service agent having advertisement data in a virtual space explored by a user, displaying a user agent in the virtual space which personifies the user and moves through the virtual space, enabling the service agent to initiate to interact with the user when the user agent approaching to the service agent, displaying the advertisement data in the service agent when the user responds to the interaction initiated by the service agent.

This summary of the invention does not necessarily describe all necessary features so that the invention may also be a sub-combination of these described features.

### BRIEF DESCRIPTION OF THE DRAWINGS

FIG. 1 shows a block diagram of an advertisement display apparatus according to an embodiment of the present invention.

FIG. 2 illustrates object data structure of a user agent.

FIG. 3 illustrates object data structure of a service agent.

FIG. 4 illustrates a plurality of service agents and a user agent in a virtual space.

FIG. 5 illustrates how a service agent converses with a user agent and presents advertisement data.

FIG. 6 illustrates data structure of an advertisement included in a service agent.

FIG. 7 illustrates a plurality of areas where a service agent may appear.

FIG. 8 is a flowchart showing an advertisement display procedure.

### DETAILED DESCRIPTION OF THE INVENTION

The invention will now be described on the basis of the preferred embodiments, which do not intend to limit the scope of the present invention, but exemplify the invention. All of the features and the combinations thereof described in the embodiment are not necessarily essential to the invention.

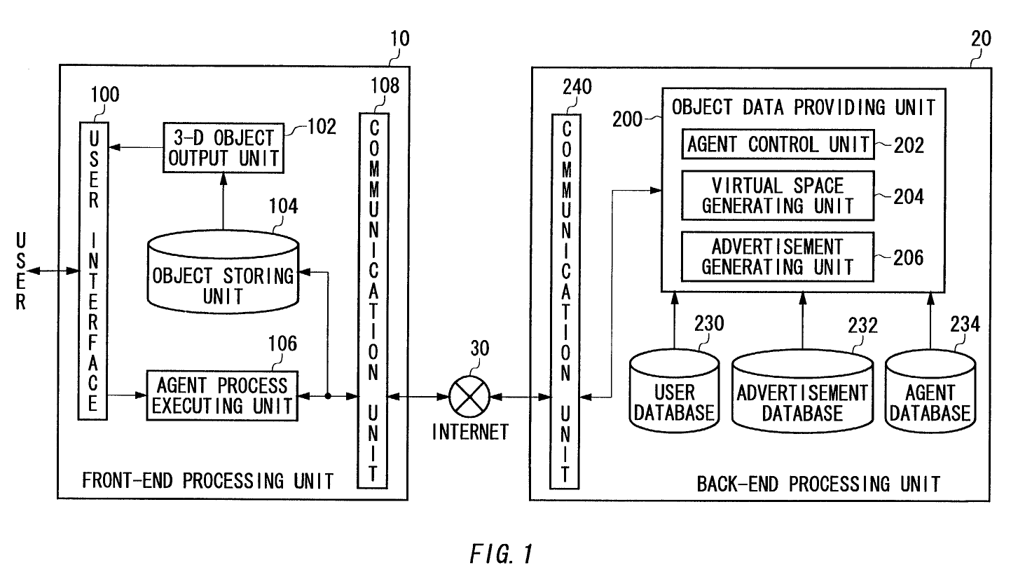

FIG. 1 shows a block diagram of an advertisement display apparatus according to an embodiment of the present invention. In this embodiment, the advertisement display apparatus is implemented as a server-client system in the Internet. The functions of the advertisement display apparatus are divided into a front-end processing unit 10 and back-end processing unit 20. The front-end processing unit 10 is implemented at the client side, and the back-end processing unit 20 is implemented at the server side. The front-end processing unit 10 and the back-end processing unit 20 are connected via the Internet 30. The front-end processing unit 10 and the back-end processing unit 20 function as a normal computer. Therefore the structure of these units may be implemented with a CPU, memory and a program loaded in the memory. In the figure, however, the blocks are not divided in terms of hardware and/or software component, but in terms of function. The skilled in the art can therefore understand that the various combinations of hardware and software components can achieve the function of these blocks.

The front-end processing unit 10 has a user interface 100 which implies all user-related functions, such as presenting information to a user, and receiving user's commands. For this purpose, the user interface 100 includes an input device such as a keyboard or a mouse, a display device, GUI and other programs.

An object storing unit 104 contains a virtual 3-D space, as also simply referred to as a virtual space, which is displayed for supporting a user, and object data describing a service agent 42 that personifies a service body which provides the user with services and interacts with the user in the virtual space, and a user agent 40 that personifies the user. A 3-D object output unit 102 displays an agent based on the object data stored in the object storing unit 104. The object data of the user agent 40 and the service agent 42 may be first stored in an agent database 23. In this case, upon the request of an agent process executing unit 106, an object data providing unit 200 retrieves the object data form the agent database 234 and sends it to the front-end processing unit 10. The front-end processing unit 10 stores the received object data to the object storing unit 104.

The virtual space holds a virtual service mall or a service store, as also simply referred to as a virtual service store. The virtual service store is associated with a Web server of the service body who provides users with services or advertising body. When a user agent enters the virtual service store, the user can access to the Web server and browse the Web pages.

The agent process executing unit 106 executes specific processes required when the user manipulates the user agent or converses with the service agent. Moreover, the agent process executing unit 106 detects whether the user agent 40 is within the neighborhood of any of service agents 42 and activates the service agent 42 that the user agent 4 approached. The activated service agent 42 starts to interact with the user agent 40. The user agent 40 and the service agent 42 are simply referred to as agents in the following.

The object data providing unit 200 has an agent control unit 202 and a virtual space generating unit 204 that provide the front-end processing unit 10 with agents and a virtual space respectively as object data. The agent control unit 202 generates and manages agents. As object data of the agent, its image data, dialogue data, and various types of attribute data such as for characterization are generated. If any new information is required during the interaction between the user agent 40 and the service agent 42 at the front-end processing unit 10, the information is obtained at the agent control unit 202 and the other processes such as Web page retrieval are performed. Furthermore, an advertisement generating unit 206 retrieves the user's personal information from a user database 230 and extracts an advertisement data that fits the user's preference from an advertisement database 232, and then provides the service agent 42 with the advertisement data. The virtual space and the agents may be implemented in for instance, VRML or virtual reality modeling language. In this case, a virtual space generating unit 20 may provide users with the functionality for viewing VRML objects.

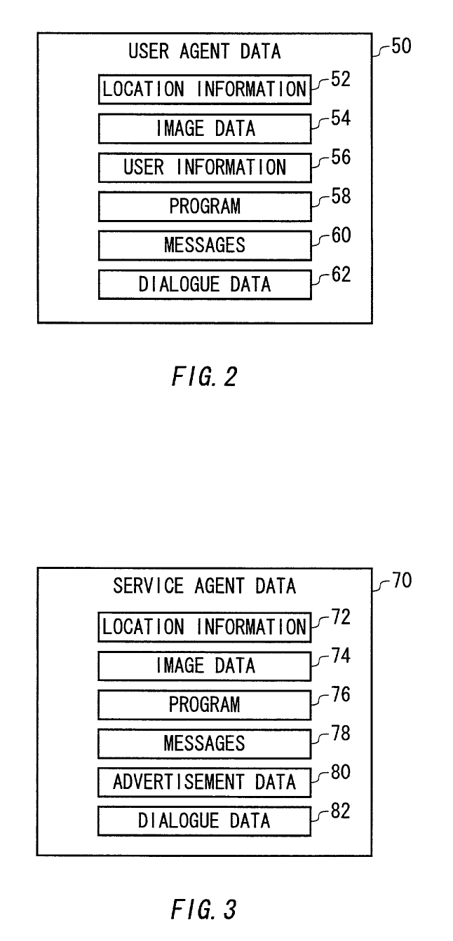

FIG. 2 illustrates the object data structure of the user agent 40. The object data of the user agent 40 includes a location information 52 that indicates the agent's location in the virtual space, the image data 54 of the agent, user information 56, a program 58 which describes the agent's behavior, typical messages 60 which the agent speak in the dialogue, and dialogue data 62 which contain the dialogue log. The user information 56 includes the user's demographic attributes such as the user's address and age, and the user's preference attributes. The user information 56 may include points to be awarded to the user.

FIG. 3 illustrates the object data structure of the service agent 42. The object data of the service agent 42 includes a location information 72 that indicates the agent's location in the virtual space, the image data 74 of the agent, a program 76 which describes the agent's behavior, a typical message 78 which the agent speak in the dialogue, an advertisement data 80 which is presented to the user, and a dialogue data 82 which contains the dialogue log.

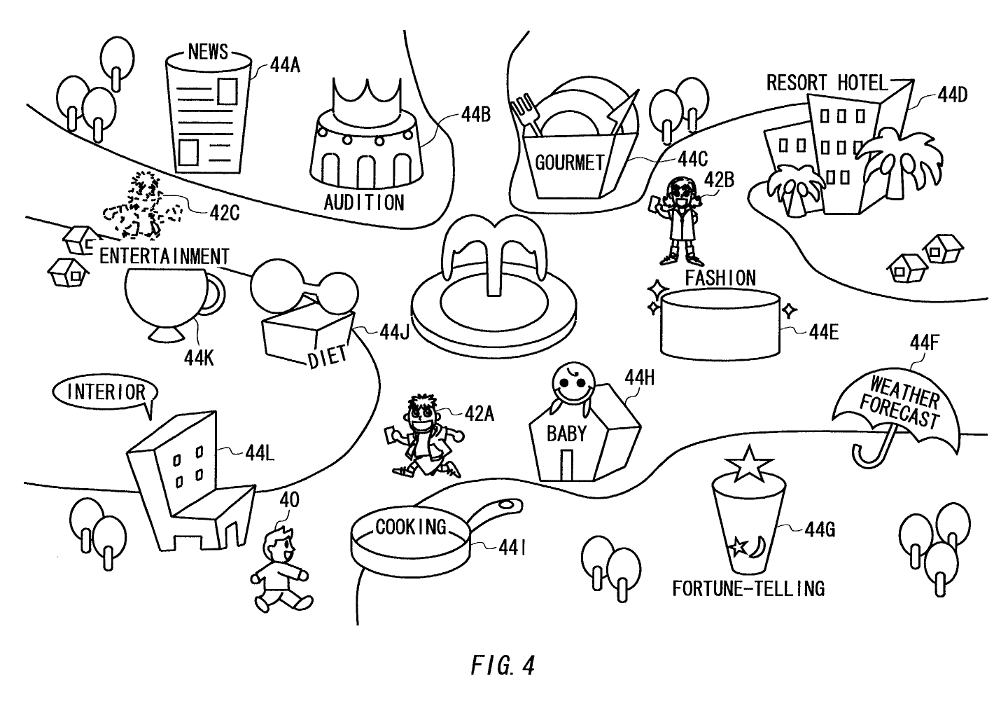

FIG. 4 illustrates the service agents arranged in the virtual space and the user agent exploring the virtual space. There exist the virtual service stores 44A to 44L, as also simply referred to as the virtual service store 44, the service agents 42A, 42B, 42C, as also simply referred to as the service agent 42, and the user agent 40. The service agents 42A and 42B are visible to the user, but the service agent 42C is invisible. The user explores the virtual space by moving the service agent 40 along the paths in the virtual space. If the user agent 40 approaches the service agent 42C, the status of the service agent 42C changes from invisible to visible so that the user can see the service agent 42C.

Once the user agent 40 comes within the neighborhood of the service agent 42, the service agent 42 starts to interact with the user agent 40. As an example, the service agent 42 personifies a person who hands out a pocket type of tissues with an attached advertisement on the street. The interaction initiated by the service agent 42 is, for instance the action of handing out the tissues or speaking to the user agent 40. If the user or the user agent 40 responds to the interaction initiated by the service agent 42, the service agent 42 presents the advertisement data to the user.

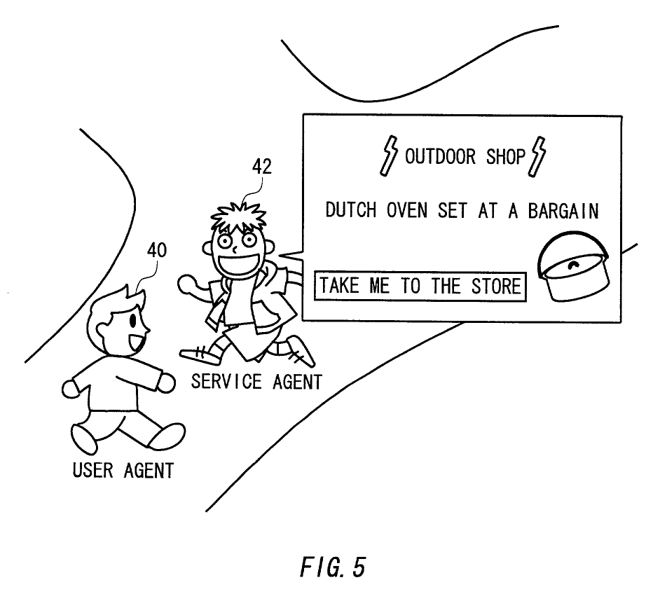

FIG. 5 illustrates how the service agent 42 converses with the user agent 40 and presents the advertisement data. The service agent 42 shows the logo of a virtual service store called “outdoor shop”, an advertising message, an image of an advertised product in the shown dialogue. The advertisement data may include a link to the server of the virtual service store. The button indicated by “take me to the store” is an example of the link. When the user click the button, the user agent 40 moves to the virtual service store, and the user can browse the Web pages offered by the store's server and purchase the products or take the services. This imitates “puller-in” in a real world and it is also an effective advertising way in the virtual reality.

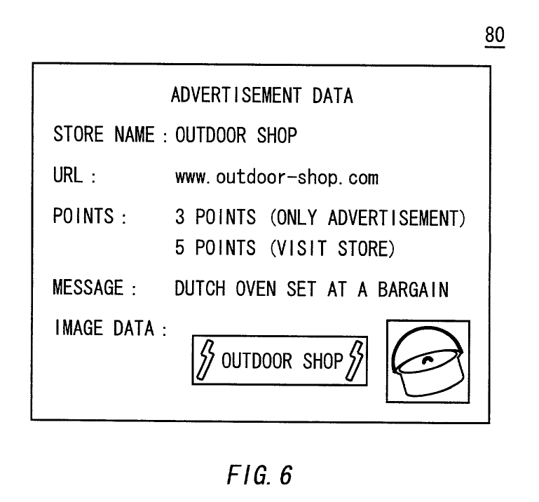

FIG. 6 illustrates the data structure of the advertisement data 80 included in the object data of the service agent 42. The advertisement data 80 includes the name of the virtual service store, the URL of the store's server, the number of points to be awarded if the advertisement is displayed to the user, the number of points to be awarded if the user agent 40 visits the virtual store, an advertising message, and the image data of the product or the service store. Based on these predefined number of the points, the user gains the points when he/she sees the advertisement and visits the store using the embedded link, and updates his/her points stored in the user information 56 of the user agent 40.

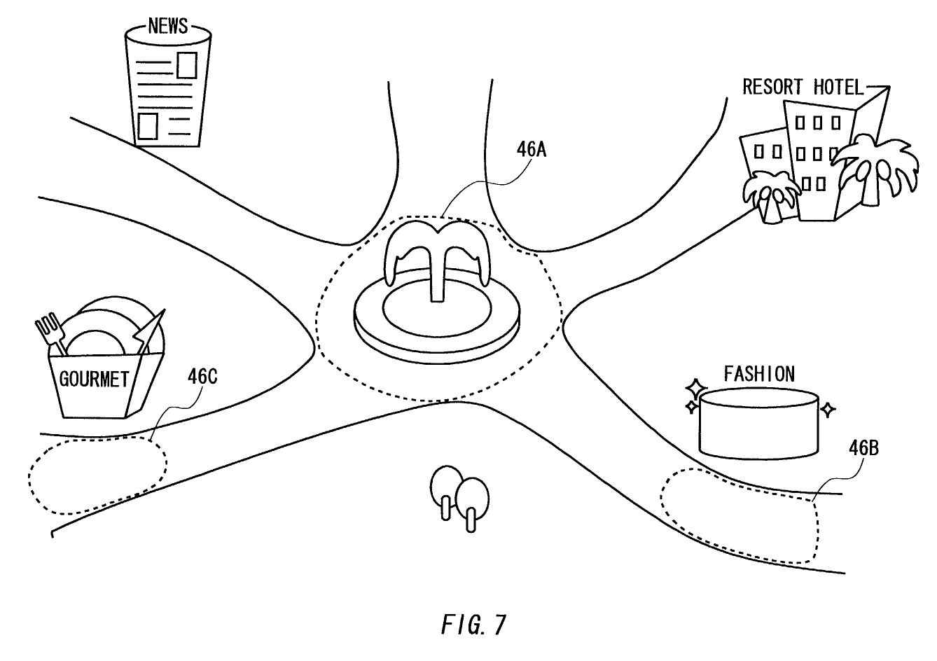

It is also configured in such a manner that the invisible service agent 42 may appear in a plurality of areas. FIG. 7 illustrates a plurality of areas where the service agent 42 may appear. The areas 46A, 46B and 46C surrounded by the dotted lines are defined as the areas where the service agent 42 can appear. In order to narrow down the target of the advertises, the advertiser can select the area 46A where the users gather like a park as in this example, or the area 46B and 46C in front of the virtual service stores specialized for the fashionable and gourmet, for example, according to the advertised contents or the advertisee bracket, and then set the service agent 42 to appear in the selected areas. When the user agent 40 enters one of the areas 46A, 46B and 46C, the service agent 42 is displayed near the user agent 40 and the interaction between them is initiated.

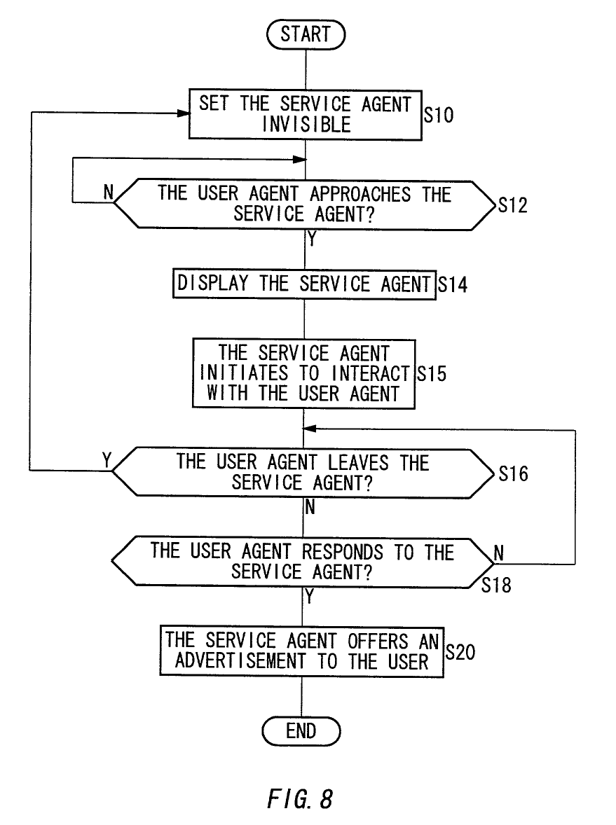

FIG. 8 is a flowchart showing an advertisement display procedure by the advertisement display apparatus having the above-mentioned configuration. The agent process executing unit 106 set invisible the service agent 42 arranged in the virtual space (S10). The agent process executing unit 106 detects whether or not the user agent 40 exists in the neighborhood of the service agent 42 (S12). If the user agent 40 is near the service agent 42 (Y of S12), the agent process executing unit 106 displays the service agent 42 (S14). The service agent 42 is activated and initiate to interact with the user agent 40 (S15). The agent process executing unit 106 detects whether or not the user agent 40 leaves the service agent 42 (S16). If the user agent 40 ignores the action initiated by the service agent 42 and passes by (Y of S16), the service agent 42 is set to invisible again (S10). Next, the agent process executing unit 106 detects whether or not the user agent 40 responds to the action initiated by the service agent 42 (S18). If the user agent 40 responds (Y of S18), the service agent 42 displays the advertisement data to the user (S20).

In the above explanation, the process performed by the agent process executing unit 106 may be executed by a program embedded in the service agent 42 or the user agent 40. For instance, a program defining the behavior of the service agent 42 may judge whether or not the user agent 40 is within the neighborhood by comparing the locations of the two.

Although the present invention has been described by way of exemplary embodiments, it should be understood that those skilled in the art might make many changes and substitutions without departing from the spirit and the scope of the present invention that is defined by the appended claims. Some such alterations are stated as follows.

A function may be provided to offer entertainment to the users. For example, a special service agent called a premium agent may be hidden in a street in the virtual space. A special gift may be awarded to the user who discovers the hidden service agent and sees the advertisement presented by the service agent. In this case, the user can be entertained by exploring the virtual apace as a game. The service agent may perform a questionnaire research to the users or ask the users a quiz, some points may be earned by the users who replied to the questionnaire and the quiz. Thus, the users can see the advertisement while enjoying the interaction with the service agent so that the user's incentive to see the advertisement can be raised and the advertising effect can be improved. Furthermore, the service agent may receive the dialogue log and select the advertisement data suitable to the users according to the user information and the dialog log.

Although the functions of the advertisement display apparatus are implemented into a server and a client separately in the above embodiment, those functions can be implemented in the server only or the client only. There may be also the various types of configurations in a manner such that the functions are divided between the server and the client.

What is claimed is:

1. An advertisement display apparatus comprising:
an object storing unit which stores object data that describe a service agent that is located in a virtual space to be explored by a user and has advertisement data, and a user agent that personifies the user;
an object outputting unit which displays the service agent and the user agent in the virtual space; and
an agent process executing unit which enables the service agent to initiates to interact with the user when the user agent is in the neighborhood of the service agent,
wherein said object outputting unit displays the advertisement data of the service agent, when the user responds to the interaction initiated by the service agent.

2. The apparatus of claim 1, wherein said object outputting unit displays the service agent when the user agent is in the neighborhood of the service agent, and makes the service agents invisible when the user agent is not in the neighborhood of the service agent.

3. The apparatus of claim 1, wherein said agent process executing unit moves the service agent to the user agent when the user agent is within a specific region defined for each of the service agents, and said object outputting unit displays the moved service agent.

4. The apparatus of claim 3, wherein a plurality of the regions where the service agent can appear are defined, and when the user agent is within any of the plurality of the regions, the service agent is moved to the user agent and displayed.

5. The apparatus of claim 1, wherein the service agent has an advertisement data provided by a virtual store in the virtual space, and said agent process executing unit moves the user agent to the virtual store when the user responds to the displayed advertisement data.

6. The apparatus of claim 2, wherein the service agent has an advertisement data provided by a virtual store in the virtual space, and said agent process executing unit moves the user agent to the virtual store when the user responds to the displayed advertisement data.

7. The apparatus of claim 1, wherein said agent process unit awards a point to the user when the user responds to the service agent and the advertisement data is displayed.

8. The apparatus of claim 5, wherein said agent process unit awards a point to the user when the user agent is moved to the virtual store.

9. The apparatus of claim 2, wherein said agent process unit awards a point to the user when the invisible service agent is discovered through the user's exploration and the advertisement data in the service agent is displayed.

10. A server shared by a plurality of users exploring a virtual space, comprising:
an advertisement database which stores advertisement data to be offered to a user;
a user database which stores the user's personal data;
a set of software components which realize a user agent that personifies the user and moves through the virtual space explored by the user; and
a set of software components which realize a service agent located in the virtual space that initiates to interact with the approaching user agent,
wherein the service agent has a function for extracting the personal data of the user corresponding to the interacting user agent, a function for extracting the advertisement data matched to the personal data from the advertisement database, and a function for presenting a user with the extracted advertisement data.

11. The server of claim 10, wherein the service agent is set to be visible when the user agent is in the neighborhood of the service agent, and set to be invisible when the user agent is not in the neighborhood of the service agent.

12. The server of claim 10, wherein the service agent presents the user with an advertisement data provided by a virtual store in the virtual space, and when the user responds to the displayed advertisement data, the user agent is moved to the virtual store.

13. The server of claim 10, wherein the user is awarded a point when the user responds to the service agent and the advertisement data is displayed.

14. A server-client system having a server shared by a plurality of users exploring a virtual space, and a user terminal accessing to the server via a network, wherein said server includes:
an advertisement database which stores advertisement data to be offered to a user; and
an object data providing unit which provides object data that describes a user agent that personifies the user and moves the virtual space explored by the user, and a service agent located in the virtual space that presents the user with the advertisement data, and
wherein said user terminal includes:
an object storing unit which stores object data of the service agent and the user agent provided by said server;
an object outputting unit which displays the service agent and the user agent in the virtual space; and
an agent process executing unit which enables the service agent to interact with the user when the user agent is in the neighborhood of the service agent, and displays the advertisement data according to the reaction of the user.

15. The system of claim 14, wherein the service agent is set to be visible at the user terminal when the user agent is in the neighborhood of the service agent, and set to be invisible when the user agent is not in the neighborhood of the service agent.

16. The system of claim 14, wherein the service agent presents the user with an advertisement data provided by a virtual store in the virtual space, and when the user responds to the displayed advertisement data, the user agent is moved to the virtual store.

17. The system of claim 14, wherein the user is awarded a point when the user responds to the service agent and the advertisement data is displayed.

18. An advertisement display method comprising:
arranging a service agent having advertisement data in a virtual space explored by a user;
displaying a user agent in the virtual space which personifies the user and moves through the virtual space;
enabling the service agent to initiate to interact with the user when the user agent approaching to the service agent; and
displaying the advertisement data in the service agent when the user responds to the interaction initiated by the service agent.

19. The method of claim 18, further comprising setting the service agent to be visible when the user agent is in the neighborhood of the service agent, and setting the service agent to be invisible when the user agent is not in the neighborhood of the service agent.

20. The method of claim 18, further comprising awarding a point to the user when the user responds to the service agent and the advertisement data is displayed.
